(19) United States
(12) Patent Application Publication
(10) Pub. No.: US 2015/0315010 A1
(43) Pub. Date: Nov. 5, 2015

(54) SELF DRAINING CHEMICAL TOTE SYSTEM STAND

(71) Applicant: THE ANDERSONS, INC., Maumee, OH (US)

(72) Inventor: Joseph H. Shaffer, Albion, MI (US)

(21) Appl. No.: 14/702,296

(22) Filed: May 1, 2015

Related U.S. Application Data
(60) Provisional application No. 61/987,149, filed on May 1, 2014.

(51) Int. Cl. B67D 7/84; F16M 11/22; F17C 13/08; F16M 11/10

(52) U.S. Cl. CPC B67D 7/84; F16M 11/10; F16M 11/22; F17C 13/08

(57) ABSTRACT

A stand for supporting a tote is provided that includes a frame forming a rectangle or square with a front side, a back side, and a right and a left side. An elevated platform is supported on said frame. A set of three side rails above the platform is attached to along the back side, the right side and the left side. At least one swing gate swingable to expose the front side of said platform. A lifting mechanism adapted to tilt said platform toward the front side. A method of use is of the stand of also provided.

### RELATED APPLICATIONS

This application is a non-provisional application that claims priority benefit of U.S. Provisional Application Ser. No. 61/987,149 filed 1 May 2015; the contents of which are hereby incorporated by reference.

### FIELD OF THE INVENTION

The present invention in general relates to material handling devices and more particularly to a stand for holding large capacity totes.

### BACKGROUND OF THE INVENTION

Manufactures realize cost savings when commodities are purchased in bulk quantities. For example, buying production chemicals in 250 gallon capacity totes provides a lower unit cost per gallon as compared to buying the production chemical in 55 gallon drums.

However, buying commodities in larger volume containers introduces additional safety and handling concerns for production personnel. Large capacity containers or totes are extremely heavy. For example, one U.S. gallon weighs approximately 8.34 pounds, while a gallon of gasoline weighs approximately 6.25 pounds. Thus, a 250 gallon container with a liquid may weigh over 2000 pounds, depending on the liquid's density, and handling and dispensing liquids from high capacity totes or containers must be done with extreme care and caution.

Thus, there exists a need for an apparatus that can accommodate large containers or totes, and for safely dispensing the totes contents into small quantities.

### SUMMARY OF THE INVENTION

A stand for supporting a tote is provided that includes a frame forming a rectangle or square with a front side, a back side, and a right and a left side. An elevated platform is supported on said frame. A set of three side rails above the platform is attached to along the back side, the right side and the left side. At least one swing gate swingable to expose the front side of said platform. A lifting mechanism adapted to tilt said platform toward the front side.

In another embodiment, a stand for supporting a tote is provided that includes a frame with upright members arranged so as to form a rectangle or square with a front side, a back side, and a right and a left side when joined together with a set of lower cross members at a bottom of said upright members, and a set of upper cross members at an upper portion of said upright members. At least one diagonal brace joins between one of the upright members and one of same side the upper cross members. A platform is provided that is formed with one or more inner supports attached to opposing upper cross members from the set of upper cross members. A set of three side rails are provided along said back side and said right and left sides. A set of two swing gates that are operative to open when the tote is being loaded unto the stand, and to close and lock and secure the tote when the tote is resting on the platform. A pull out shelf is provided for holding a smaller container under a spigot of the tote for filling the smaller container with content from the tote. A lifting mechanism is provided that is operative to tilt the tote forward toward the front side when said tote is positioned on said platform.

A method of operation of the stand is also provided that increases worker safety and tote utilization.

### BRIEF DESCRIPTION OF THE DRAWINGS

FIGS. 1A and 1B are front perspective views of a tote stand with a tote loaded according to an embodiment of the invention;

FIG. 2 is a close up view of the tote stand of FIGS. 1A and 1B showing the retaining swing gates in a closed and locked position with the tote loaded according to an embodiment of the invention;

FIGS. 3A-3C are close up views of the jack bolt system of the tote stand of FIGS. 1A and 1B that raise and lower the tote according to an embodiment of the invention; and

FIGS. 4A and 4B are close up views of a retractable pull out shelf for holding a container to be filled when dispensing a liquid from a tote loaded on the stand according to an embodiment of the invention.

### DESCRIPTION OF THE INVENTION

The present invention has utility as a stand for safely holding a high capacity tote or container while dispensing liquids, and for emptying and cleaning out the tote. Embodiments of the inventive stand hold a tote at a height that is ergonomically friendly, and allows an operator to fill a smaller container without excessive bending. Embodiments of the inventive stand have a rectangular modular construction with four upright members acting as legs that support a platform formed from four upper cross members joined to the upright members and one or more inner supports joined to opposing sides of the upper cross members for holding a high capacity tote. For added strength, the lower portions of the upright members are also joined by four lower cross members, as well as diagonal braces between the upper cross members and the upright members. In certain embodiments the cross members and braces may be joined to the uprights with securements such as bolts, or by welding. The upright members, upper and lower cross members, and braces may be made of steel, alloys, or high strength composites. In order to secure the tote, the upper platform has side rails extending on three sides above the tote holding platform, while the front facing side of the platform has a set of two swing gates that are operative to open when the tote is being loaded unto the stand, and to lock and secure the tote when the tote is resting on the platform of the inventive stand.

Embodiments of the inventive stand are configured with a pull out shelf for holding a smaller container under a spigot of the tote for filling the smaller container with content from the tote. In specific embodiments the shelf retracts when not in use or when the tote is being loaded or unloaded from embodiments of the inventive stand. In a specific embodiment the self may slide on a set of sealed bearings for ease of cleaning the stand and to avoid contaminants from entering the movement mechanism.

In order to facilitate the empty and cleaning of a tote resting in the inventive stand, the tote can be tilted by raising one side of the tote with a lifting mechanism so that any remaining liquid and sediments at the base of the tote may be cleared. In certain embodiments of the tote stand, the lifting mechanism may be implemented with a jack bolt system to raise the tote for ease of emptying and cleaning out of tote. In a specific embodiment a one inch jack bolt system may be used to raise and tilt the tote. With the jack bolt no extra forklift handling is required for this tilting and emptying procedure. In operation an operator rotates the two cranks to raise or lower the side away from the spout. In the past pumping out and/or lifting of back end of the tote was required to fully empty the tote. In further specific embodiments, a different mechanism for lifting and tilting the tote may include electric or electronically controlled lift, or a pneumatic or hydraulic actuation device.

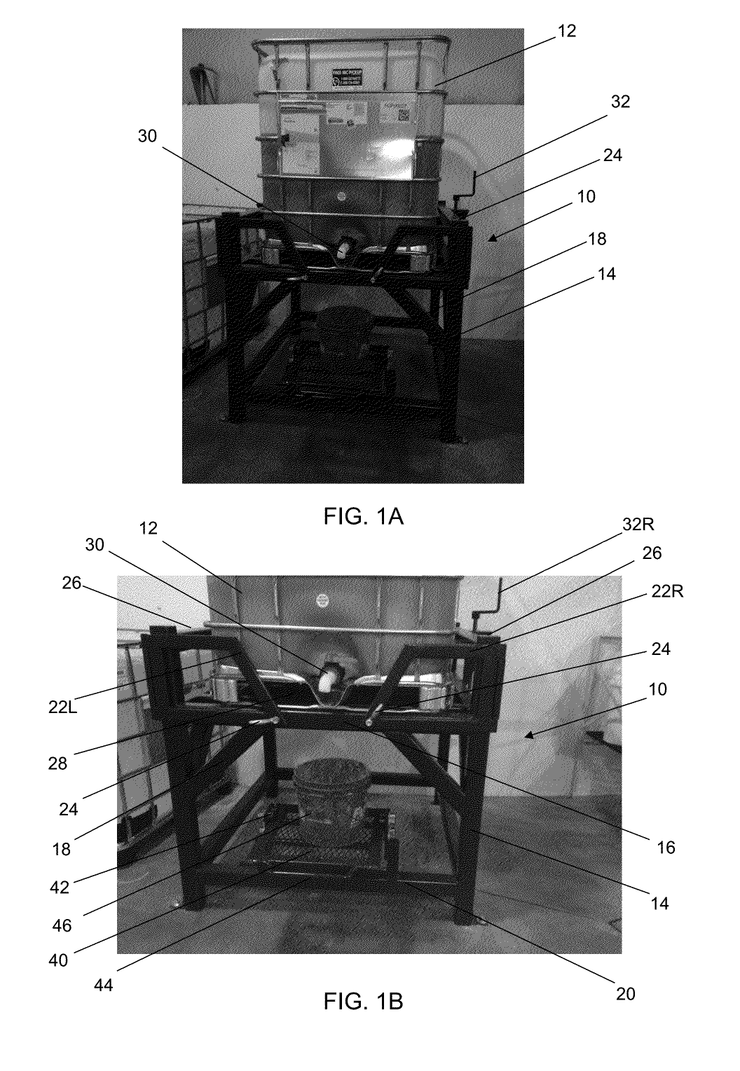

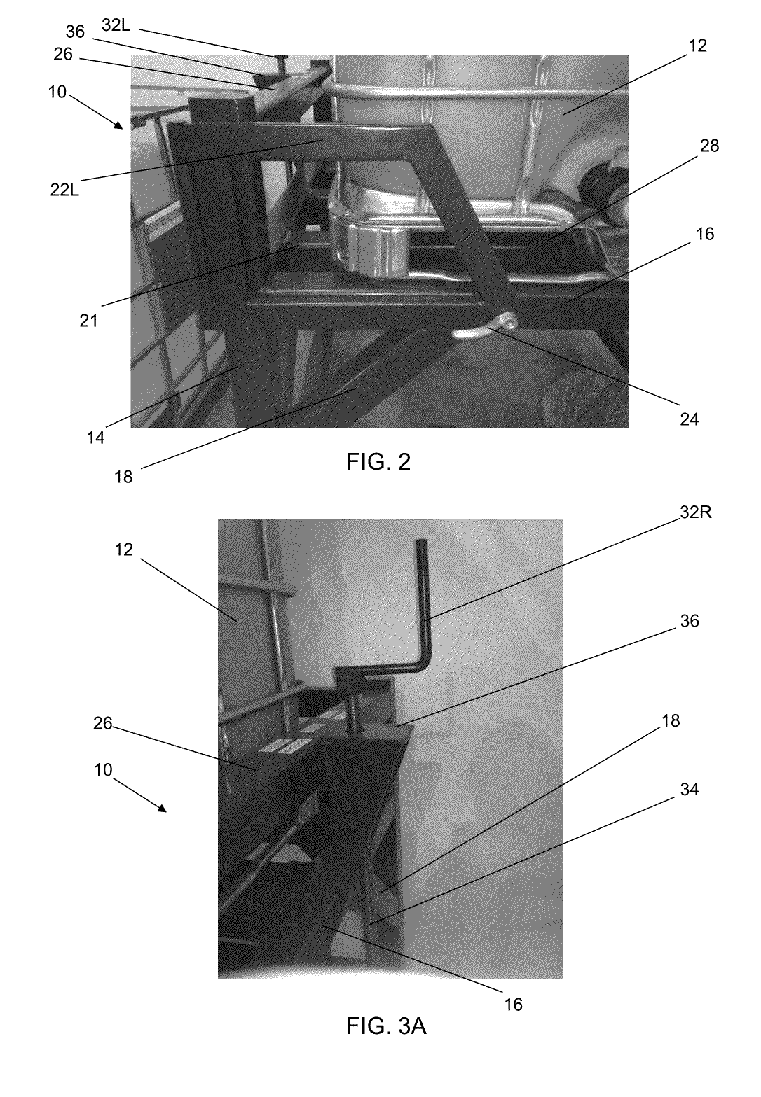

Referring now to the figures, FIGS. 1A and 1B, as well as FIG. 2, show an inventive embodiment of a stand 10 for holding a tote 12. The stand 10 has four upright members 14 acting as legs that are joined together at their upper portion by a platform formed from four (right, left, front, rear) upper cross members 16 and one or more inner supports 21 joined to right and left upper cross members 16 for holding a high capacity tote 10. It is noted that the tote 12 has a pallet base with opening 28 for a forklift to move and raise the tote 12 to be placed on the platform. For added strength the lower portions of the upright members 14 are also joined by four (right, left, front, rear) lower cross members 20, as well as diagonal braces 18 between the upper cross members 16 and the upright members 14. In certain embodiments the cross members (16, 20) and braces 18 may be joined to the uprights 14 with securements such as bolts, or by welding. In order to secure the tote 12, the upper platform has side rails 26 extending on three sides from the tops of the upright members 14 above the tote holding platform, while the front facing side of the platform has a set of two swing gates (22R, 22L) that are operative to open when the tote is being loaded unto the stand 10, and to lock and secure the tote 12 when the tote 12 is resting on the platform with handles 24.

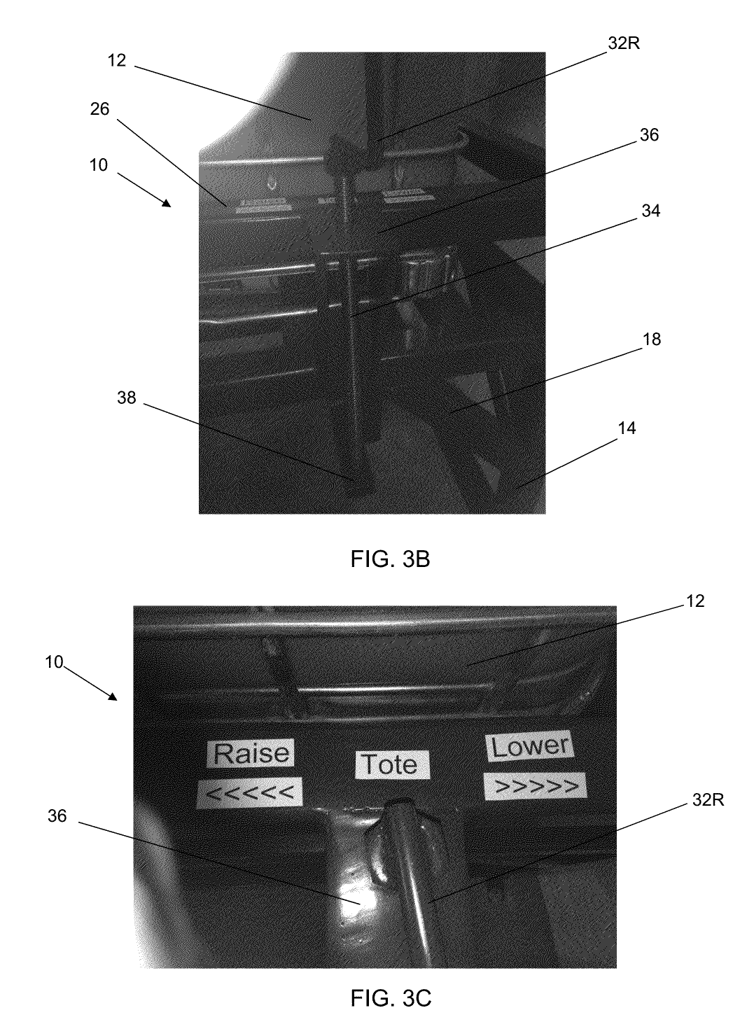

Continuing with FIGS. 1A and 1B, and as shown in greater detail in FIGS. 3A-3C, in order to facilitate the emptying and cleaning of a tote 12 resting in the inventive stand 10, the tote 12 can be tilted by raising one side of the tote 12 with a lifting mechanism so that any remaining liquid and sediments at the base of the tote may be cleared via the spot 30. In certain embodiments of the tote stand 10, the lifting mechanism may be implemented with a jack bolt system to raise the tote 12 for ease of emptying and cleaning out of the tote 12. In a specific embodiment a one inch jack bolt system may be used to raise and tilt the tote 12. With the jack bolt no extra forklift handling is required for this tilting and emptying procedure. In operation an operator rotates the two cranks 32R and 32L (partially visible in FIG. 2) to raise or lower the side away from the spout 30, as the two threaded jack bolts (34R, 34L) each engage a threaded hole in standoffs 36R (36L not visible) attached to the right and left upper cross members 16. The jack bolts (34R, 34L) push off stop 38R (38L not visible) as the bolts (34R, 34L) are turned with the cranks and the upper cross members. As shown in the example embodiment of FIG. 3C, a counter clockwise rotation of the crank 32R raises the tote 12, and conversely a clockwise rotation of the crank 32R lowers the tote 12.

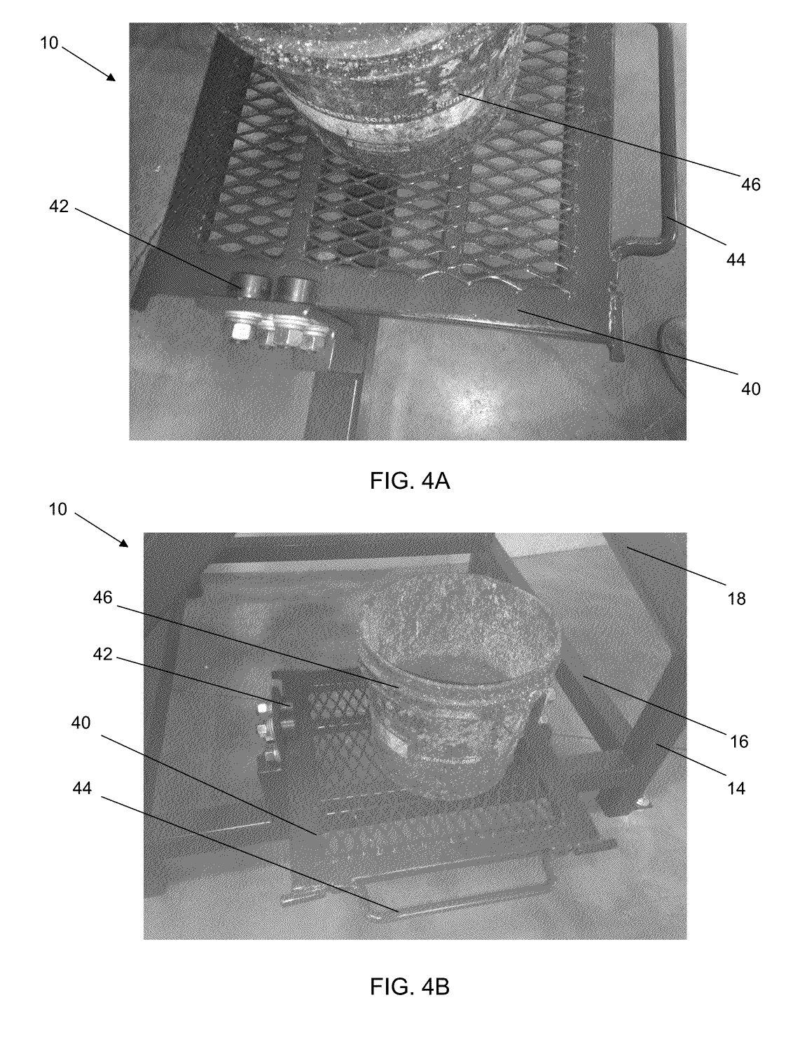

FIGS. 4A and 4B illustrate an embodiment of a pull out shelf 40 for holding a smaller container, such as but not limited to a bucket 46, under the spigot 30 of the tote 12 for filling the smaller container with content from the tote. In specific embodiments the shelf 40 retracts when not in use or when the tote 12 is being loaded or unloaded from embodiments of the inventive stand 10. In a specific embodiment the shelf 40 slides on a set of sealed bearings 42 for ease of cleaning the stand and to avoid contaminants from entering the movement mechanism. An operator can pull the shelf 40 by a handle 44.

The foregoing description is illustrative of particular embodiments of the invention, but is not meant to be a limitation upon the practice thereof. The following claims, including all equivalents thereof, are intended to define the scope of the invention.

1. A stand for supporting a tote comprising:
a frame forming a rectangle or square with a front side, a back side, and a right and a left side;
an elevated platform supported on said frame;
a set of three side rails above said platform attached to along the back side, the right side and the left side;
at least one swing gate swingable to expose the front side of said platform; and
a lifting mechanism adapted to tilt said platform toward the front side.

2. The stand of claim 1 wherein said frame is formed of four upright members joined together with a set of four lower cross members at a bottom of said upright members, and a set of four upper cross members at an upper portion of said upright members.

3. The stand of claim 2 further comprising a set of diagonal braces joined between each of said upright members and said upper cross members.

4. The stand of claim 2 wherein said upright members, upper and lower cross members, and braces are made of at least one of steel, alloys, or high strength composites.

5. The stand of claim 2 wherein said upright members, upper and lower cross members, and said diagonal braces are joined by securements.

6. The stand of claim 2 wherein said upright members, upper and lower cross members, and said diagonal braces are joined by welded joints.

7. The stand of claim 1 wherein said lifting mechanism comprises a set of jack bolts positioned on said right and said left sides of said stand.

8. The stand of claim 1 wherein said lifting mechanism comprises an electric or electronically controlled lift.

9. The stand of claim 1 wherein said lifting mechanism comprises a pneumatic or hydraulic actuation device.

10. The stand of claim 1 further comprising a set of sealed bearings for slideably connecting said shelf to said stand.

11. The stand of claim 1 further comprising a pull out shelf positioned under the front side of the platform.

12. The stand of claim 1 wherein said at least one swing gate is a pair of opposing swing gates having a gap therebetween in a closed position.

13. A method of using the stand of claim 1; said method comprising:
placing a tote on said platform;
pulling out said shelf from said stand and placing a container on said shelf;
filling said container with contents from said tote;
removing said container from said self; and
pushing said shelf back under said stand.

14. The method of claim 13 further comprising tilting said tote with said lifting mechanism to clean and fully empty the tote.
